(19) United States
(12) Patent Application Publication
(10) Pub. No.: US 2024/0008494 A1
(43) Pub. Date: Jan. 11, 2024

(54) COMPOSITION OF PREDATORY NEMATODES AND METHODS OF USING SAME

(71) Applicant: The State of Israel, Ministry of Agriculture & Rural Development, Agricultural Research Organization, Rishon Lezion (IL)

(72) Inventors: Sigal BROWN, Ness Ziona (IL); Orly OREN, Kfar Menahem (IL); Yitzhak SPIEGEL, Ness Ziona (IL); Yinon MAZAR, Rehovot (IL); Ralf-Udo EHLERS, Schwentinental (IL)

(21) Appl. No.: 18/038,489

(22) PCT Filed: Nov. 24, 2021
(86) PCT No.: PCT/IL2021/051400

§ 371 Date: May 24, 2023

Related U.S. Application Data
(60) Provisional application No. 63/117,652, filed on Nov. 24, 2020.

(51) Int. Cl. A01N 63/12; A01P 5/00

(52) U.S. Cl. CPC A01N 63/12; A01P 5/00

(57) ABSTRACT

The present invention is directed to a synthetic nematocidal composition comprising a mixture of developmental stages of a predatory nematode, and methods of using same, such as for protecting a plant from a plant-parasitic nematode.

### CROSS-REFERENCE TO RELATED APPLICATIONS

This application claims the benefit of priority of U.S. Provisional Patent Application No. 63/117,652, titled “COMPOSITION OF PREDATORY NEMATODES AND METHODS OF USING SAME”, filed Nov. 24, 2020, the contents of which are incorporated herein by reference in their entirety.

### FIELD OF INVENTION

The present invention is in the field of biocontrol, such as for reducing plant damage due to pathogenic nematodes.

### BACKGROUND

Phytonematodes, such as, but not limited to, the root-knot nematodes (RKN), Meloidogyne sp. are among the world's most devastating plant pathogens, causing substantial yield losses in nearly all major agricultural crops. They are found in all regions that have mild cold or warm temperatures and are regarded as one of the most serious threats to agriculture as climate change progresses. In their life-cycle, species of the Meloidogyne sp. group hatch in the soil and invade a root. Once inside the roots, the worms form the characteristic knots from which their name arises. Each knot contains at least one nematode feeding from a unique cell-type (the giant cells), surrounded by a gall of dividing cortical cells.

Phytonematodes account for an estimated 14% of all worldwide plant losses, translated into ca. $90 billion dollars annually. Due to the controversial effect of nematicides and gradual phase-out of several prominent chemical nematicides in the last years including the ban of methyl bromide, there is a need for better generic, effective and non-hazardous nematicides.

### SUMMARY

According to a first aspect, there is provided a synthetic nematocidal composition comprising a mixture of developmental stages of a predatory nematode belonging to the genus Allodiplogaster comprising eggs, juveniles, dauers, and adults, and an acceptable carrier.

According to another aspect, there is provided a method for protecting a plant or a part thereof from a plant-parasitic nematode, the method comprising treating the plant or a part thereof with an effective amount of the synthetic nematocidal composition of the invention.

In some embodiments, at least 2% of the predatory nematodes in the mixture are dauers.

In some embodiments, at least 10% of the predatory nematodes in the mixture are dauers.

In some embodiments, at least 10% of the predatory nematodes in the mixture are eggs.

In some embodiments, the predatory nematode is Allodiplogaster sudhausi.

In some embodiments, the acceptable carrier is selected from the group consisting of: a liquid carrier, a gel carrier, a mineral carrier, a solid carrier, and any combination thereof.

In some embodiments, the liquid carrier is further encapsulated in a suitable compound.

In some embodiments, the gel carrier comprises a naturally occurring polymer, a synthetic polymer, or a combination thereof.

In some embodiments, the naturally occurring polymer comprises alginate, carrageenan, or a combination thereof.

In some embodiments, the synthetic polymer comprises sodium-polyacrylate.

In some embodiments, the mineral carrier comprises Silicium dioxide, vermiculite, diatomaceous earth, or a combination thereof.

In some embodiments, the solid carrier comprises a synthetic solid carrier.

In some embodiments, the solid carrier is a porous carrier.

In some embodiments, the solid carrier comprises a sponge or a gauze.

In some embodiments, the carrier is further formulated with water, so as to provide moist environment, aerated environment, or both, to the mixture of developmental stages of the predatory nematode.

In some embodiments, the mixture of predatory nematode and the carrier are present in the synthetic nematocidal composition in a weight per weight (w/w) ratio ranging from 1:40 to 1:100.

In some embodiments, treating comprises applying the synthetic nematocidal composition to a growth medium comprising the plant-parasitic nematode, the plant, or both.

In some embodiments, treating comprises applying the synthetic nematocidal composition to the plant or a part thereof.

In some embodiments, treating is before the plant is planted, at the day the plant is planted, after the plant is planted, or any combination thereof.

In some embodiments, protecting comprises reducing the pathogenicity of the plant-parasitic nematode.

In some embodiments, reducing the pathogenicity of the plant-parasitic nematode comprises predating of the plant-parasitic nematode by the predatory nematode, reducing the survival of the plant-parasitic nematode, or both.

In some embodiments, reducing the pathogenicity of the plant-parasitic nematode comprises: reducing the average number of eggs, cysts, J2, J3, J4, adult male, adult female, or any combination thereof, of the plant-parasitic nematode per weight of a part of the plant, reducing the root galling index of the root of the plant, reducing the penetration rate of the plant-parasitic nematode to a part of the plant, reducing the number of the plant-parasitic nematode penetrating a part of the plant, or any combination thereof.

In some embodiments, the part of a plant comprises root, tuber, foliage, or any combination thereof.

In some embodiments, treating is at least once 1 to 15 days before the plant is planted.

In some embodiments, treating is at the day the plant is planted.

In some embodiments, treating is at least once 5 to 28 days after the plant is planted.

In some embodiments, the method further comprises treating the plant or a part thereof with an effective amount of a second nematocidal composition comprising the predatory nematode.

In some embodiments, about 75% of the predatory nematodes of the second nematocidal composition are adult predatory nematodes.

In some embodiments, the plant-parasitic nematode is an endo-parasite, an ecto-parasite, or an ecto-endo parasites.

In some embodiments, the plant-parasitic nematode is capable of inducing a plant immune response in a plant infected by the plant-parasitic nematode.

In some embodiments, the plant immune response comprises gall formation.

In some embodiments, the plant-parasitic nematode belongs to the genus Meloidogyne or Pratylenchus.

In some embodiments, the plant-parasitic nematode comprises M. incognita, M. javanica, P. capsici, or any combination thereof.

In some embodiments, the method further comprises a step of treating the plant or a part thereof with a nematocidal agent.

In some embodiments, the nematocidal agent is selected from the group consisting of: Nimitz, Viva, Bionem, and any combination thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIGS. 1A-1C include vertical bar graphs and a micrograph showing that pre planting application of predatory nematodes, reduces infection Meloidogyne javanica (M.j.). (1A) a vertical bar graph showing galling index in tomato roots, as follows: untreated (control), treated with predatory nematodes 10 days before planting (T₋₁₀), treated with predatory nematodes 5 days before planting (T₋₅), or treated with predatory nematodes at the day of planting (T₀). (1B) representative images of M.j. untreated tomato roots (control) or of tomato roots grown in media treated with predatory nematodes 10 days before planting (T₋₁₀). (1C) a vertical bar graph showing the total number of M.j. eggs collected from the roots of tomato plants treated as in FIG. 1A.

FIGS. 2A-2B include vertical bar graphs showing galling index of M.j. (2A) and M.j. eggs per gr roots (2B) of tomato roots of plants planted in growth media of M.j. untreated (control) or treated with predatory nematode at the day of plant planting (T₀), days before planting (T₋₅), or 10 days before planting (T₋₁₀).

FIGS. 3A-3C include vertical bar graph showing the enhanced nematocidal effect on M.j.-infected plants of the predatory nematodes of the invention (formula) applied concomitantly with a chemical nematocidal agent (Viva or Nimitz). (3A) Galling index; (3B) Total number of M.j. eggs; and (3C) M.j. eggs per gr roots.

FIGS. 4A-4B include vertical bar graphs showing galling index (4A) and M.j. eggs per gr roots (4B) of M.j.-infected tomato plants planted in growth media untreated (control) or treated with predatory nematode formulation of the invention (formula) at the day of plant planting and 10 days after planting (0, 10), 10 days before planting and at the day of planting (−10, 0), and 10 days before planting, at the day of planting, and days after planting (−10, 0, 10).

FIGS. 5A-5B include vertical bar graphs showing predation of M. javanica parasitic nematode by Allodiplogaster sudhausi after 48 hours and after 5 days (5A); and the recovery of formulated dauer at the time of application, 48 hours post application, and 5 days post application (5B).

FIG. 6 includes a graph showing the recovery of predatory nematode dauer from formula and predatory efficiency. J3—third stage juvenile; J4—fourth stage juvenile; M.j.—M. javanica.

FIG. 7 includes a vertical bar graph showing the predation of the plant-parasitic nematode Pratylenchus capsici by: 500 or 1,000 A. sudhausi (Ks) predatory nematodes. Survival rates of P. capsica were recorded after 24 and 48 hours.

FIG. 8 includes a vertical bar graph showing galling index of M.j. of cucumber roots of plants planted in growth media of M.j. untreated (control) or treated with predatory nematode (30,000 Allo. sud.), either by drenching (“hand application”) or drip irrigation.

### DETAILED DESCRIPTION

### Nematocidal Composition

According to some embodiments, there is provided a synthetic nematocidal composition comprising a mixture of developmental stages of a predatory nematode belonging to the genus Allodiplogaster.

In some embodiments, the synthetic composition further comprises an acceptable carrier.

In some embodiments, the mixture of developmental stages comprises eggs, juveniles, dauers, and adults of the predatory nematode.

As used herein, the term “nematocidal” refers to any agent or compound capable of affecting nematodes so as to reduce the survival, activity, fitness, well-being, viability, or any combination thereof, of a nematode.

As used herein, the term “synthetic” refers to the composition of the invention comprising a mixture of elements or ingredients, e.g., a predatory nematode of various developmental stages distributed to % which are not found in nature, a combination of a predatory nematode and a carrier which are not found together in nature, or a combination thereof. In some embodiments, synthetic refers to a composition comprising elements or ingredients, each of which separately occurs in nature, however, their combination, e.g., the composition of the invention, does not occur in nature. In some embodiments, synthetic is a man-made product.

As provided herein, the activity attributed to the synthetic composition disclosed herein, e.g., protection of a plant or a part derived therefrom from a plant-parasitic nematode stems from the unique non-naturally occurring distribution of the various developmental stages of the predatory nematode, as disclosed herein.

In some embodiments, the predatory nematode of the invention is a genetically modified nematode.

As used herein, the term “genetically modified” refers to the predatory nematode of the invention comprising at least one genetic modification, e.g., insertion, deletion, knock-in, knock-out, inversion, any combination thereof, or any other molecular modification of the nematode's genome that is known to a person of skill in the art, compared to a wild type or a background predatory nematode.

In some embodiments, the nematocidal activity is specifically nematocidal activity.

In some embodiments, “specific nematocidal activity” refers to the agent, compound, or composition comprising same affects only or predominantly nematodes, e.g., a plant-parasitic nematode. In some embodiments, the agent, compound, or composition comprising same does not affect any organism excluding or but a plant-parasitic nematode. In some embodiments, the agent, compound, or composition comprising same does not induce adverse effects in any organism excluding or but a plant-parasitic nematode. In some embodiments, the agent, compound, or composition comprising same reduces the pathogenicity of the plant-parasitic nematode, with minimal or no adverse effects over any other organism excluding or but the plant-parasitic nematode.

In some embodiments, the nematocidal composition of the invention is characterized by or comprises an activity affecting a pathogenic nematode.

In some embodiments, at least 2%, at least 5%, at least 7%, at least 15%, at least 25%, at least 35%, at least 45%, at least 50%, at least 60%, at least 70%, at least 80%, at least 90%, at least 95%, at least 99%, of the predatory nematodes in the mixture are dauers, or any value and range therebetween. Each possibility represents a separate embodiment of the invention. In some embodiments, 2-5%, 1-7%, 4-15%, 3-25%, 10-35%, 15-45%, 5-50%, 10-99% of the predatory nematodes in the mixture are dauers. Each possibility represents a separate embodiment of the invention.

In some embodiments, at least 8%, at least 10%, at least 12%, at least 15%, at least 25%, at least 35%, or at least 40% of the predatory nematodes in the mixture are eggs, or any value and range therebetween. Each possibility represents a separate embodiment of the invention. In some embodiments, 2-5%, 1-7%, 4-15%, 3-25%, 10-35%, 15-45%, or 5-50% of the predatory nematodes in the mixture are dauers. Each possibility represents a separate embodiment of the invention.

In some embodiments, the predatory nematode is Allodiplogaster sudhausi.

In some embodiments, the acceptable carrier is selected from: a liquid carrier, a gel carrier, a mineral carrier, a solid carrier, or any combination thereof.

In some embodiments, a liquid carrier is further encapsulated in a suitable compound. In some embodiments, the compound is configured to slow or controlled release of a liquid encapsulated therein.

Compounds suitable for encapsulation of a liquid and subsequent slow or controlled release are common and would be apparent to one of ordinary skill in the art. Non-limiting examples of encapsulating compounds, include but are not limited to: modified soluble starch, modified water-soluble microcrystalline cellulose, maltodextrin, maize treacle, trehalose, plant water-soluble glue class gum arabic, pectin, carrageenin, tamarind seed polysaccharide glue, locust bean gum, tragacanth gum, guar gum, protein whey-protein, gelatin, casein food grade, chitosan, propyl-ester lactide, polycaprolactone-polyethylene oxide, polylactide, Poly(D,L-lactide-co-glycolide, aliphatic polyester, Polyalkylcyanoacrylanano, water soluble amino resin, water soluble alkyd resin, or any combination thereof, among others.

In some embodiments, a gel carrier comprises a naturally occurring polymer, a synthetic polymer, or a combination thereof.

In some embodiments, a gel carrier polymer comprises a polysaccharide. In some embodiments, a naturally occurring polymer comprises alginate, carrageenan, or a combination thereof. In some embodiments, a synthetic polymer comprises polyacrylate. In some embodiments, polycarbonate comprises sodium-polycarbonate.

Other types of gel carriers are common and would be apparent to one of ordinary skill in the art.

Non-limiting examples of gel materials, include but are not limited to: polyacrylamide (PAM), collagen-GAG, collagen, fibrin, fibronectin, poly-l-lactic acid (PLLA), polylactic glycolic acid (PLGA) PLLA-PLGA co-polymer, poly(anhydride), poly(hydroxy acid), poly(ortho ester), poly(propylfumerate), poly(caprolactone), polyamide, polyamino acid, polyacetal, polycyanoacrylate, polyurethane and polysaccharide, polypyrrole, polyaniline, polythiophene, polystyrene, polyester, polyurea, poly(ethylene vinyl acetate), polypropylene, polymethacrylate, polyethylene, polycarbonate, poly(ethylene oxide), polypyrrole, polycaprolactone and poly(ethersulfone), poly(acrylonitrile-co-methylacrylate) (PAN-MA), or silicone.

In some embodiments, a mineral carrier comprises silicium dioxide, vermiculite, diatomaceous earth or a combination thereof.

In some embodiments, a mineral carrier comprises aggregates. In some embodiments, a mineral carrier is powder. In some embodiments, a mineral carrier is a dry powder. In some embodiments, a mineral carrier is to be moisturized so as to carry the predatory nematode mixture of the invention. In some embodiments, the mineral carrier is moisturized with water or any equivalent physiological solution providing suitable conditions for survival, activity, or both, of the mixture of predatory nematode of the invention. In some embodiments, a mineral carrier is or comprises a wettable powder. In some embodiments, a mineral carrier is compressible to form water-dispersible particles.

Non-limiting examples of mineral carrier include, but are not limited to: silica, talc, kaolin, limestone, chalk, red basalt, loess, clay, dolomite, diatomite, calcium sulfate, magnesium sulfate, magnesium oxide, any combination thereof, or others which would be apparent to one of ordinary skill in the art.

In some embodiments, a solid carrier comprises a synthetic solid carrier.

In some embodiments, a solid carrier comprises a sponge or a gauze. In some embodiments, a sponge comprises a naturally occurring sponge or a synthetic sponge.

In some embodiments, a solid carrier is porous or perforated. In some embodiments, the solid carrier is structured so as to provide flow of gas (e.g., air), liquid (e.g., water, or any equivalent physiological solution), or both, through holes, pores, voids, or any combination thereof, of the solid carrier. In some embodiments, a flow comprises diffusion. In some embodiments, flow is free flow. In some embodiments, a flow does not require appliance of pressure. In some embodiments, flow is free flow. In some embodiments, a flow does not require appliance of high pressure.

In some embodiments, high pressure comprises any pressure greater than 1 atmosphere.

As used herein, the terms “porous”, “perforated”, and “fenestrated” refer to any matrix comprising pores and/or voids and are used herein interchangeably.

Types of solid carriers suitable for carrying the mixture of developmental stages of the predatory nematode of the invention would be apparent to one of ordinary skill in the art. Non-limiting examples of such carriers include, but are not limited to: ammonium sulfate, ammonium phosphate, ammonium nitrate, urea, corn meal, bark crepe meal, wood meal, nutshell meal, cellulose powder, or any combination thereof, among many others.

In some embodiments, the carrier is further formulated with water or any equivalent physiological solution providing suitable conditions for survival, activity, or both, of the mixture of predatory nematode of the invention. In some embodiments, the carrier is further formulated with water or any equivalent physiological solution so as to provide moist environment, aerated environment, or both, to the mixture of predatory nematode of the invention.

In some embodiments, the carrier is a sterile carrier. In some embodiments, sterile is sterilized from microorganisms, e.g., bacteria. In some embodiments, the carrier is devoid of microorganisms. In some embodiments, the carrier is devoid of microorganisms which the predatory nematode disclosed herein may feed on. In some embodiments, the carrier comprises microorganisms inert to the predatory nematode disclosed herein.

As used herein, the term “inert” refers to any microorganism which does not interact with the predatory nematode disclosed herein. In some embodiments, interact comprises: (i) serve as feed of the predatory nematode, (ii) being eaten by the predatory nematode, (iii) produces, secretes, or both, metabolites affecting the survival, development, predatory activity, or any combination thereof, of the predatory nematode, or (iv) any combination of (i) to (iii).

Methods and means for sterilization are common and would be apparent to one of ordinary skill in the art. Non-limiting examples for sterilization include, but are not limited to heat sterilization (e.g., such as in an autoclave), chemical sterilization, among others.

In some embodiments, the mixture of predatory nematode of the invention composition and the acceptable carrier are homogenously dispersed in the herein disclosed composition.

In some embodiments, the mixture of predatory nematode and the carrier are present in the composition of the invention in a weight per weight (w/w) ratio ranging from a 1:30 (w/w) to 1:150 (w/w) comprises 1:35 (w/w) to 1:100 (w/w), 1:40 (w/w) to 1:175 (w/w), 1:45 (w/w) to 1:200 (w/w), 1:50 (w/w) to 1:300 (w/w), 1:55 (w/w) to 1:140 (w/w), 1:45 (w/w) to 1:500 (w/w), 1:60 (w/w) to 1:350 (w/w), 1:65 (w/w) to 1:425 (w/w), 1:75 (w/w) to 1:450 (w/w), 1:100 (w/w) to 1:750 (w/w), 1:35 (w/w) to 1:545 (w/w), or 1:70 (w/w) to 1:1,000 (w/w). Each possibility represents a separate embodiment of the invention.

In some embodiments, the mixture of predatory nematode and the carrier are present in the composition of the invention in a w/w ratio ranging from 1:40 to 1:100.

In some embodiments, the synthetic composition of the invention is preserved in a temperature suitable for maintaining the distribution of each of the developmental stages of the predatory nematode as disclosed herein, such that the predatory activity towards a plant pathogenic nematode as disclosed herein is preserved.

In some embodiments, “preserved” or “preservation” period comprises any stage or period after the synthetic composition disclosed herein is produced or synthesized until being applied according to the herein disclosed method. In some embodiments, the preserved or preservation period comprises the shipping time or period from the production site to the end user and/or the field or any site of application of the synthetic composition, e.g., a greenhouse, etc.

In some embodiments, the temperature suitable for maintaining the distribution of each of the developmental stages of the predatory nematode as disclosed herein, such that the predatory activity towards a plant pathogenic nematode as disclosed herein is preserved, is 2° C. at most, 3° C. at most, 4° C. at most, 5° C. at most, 6° C. at most, 7° C. at most, 8° C. at most, 9° C. at most, 10° C. at most, 12° C. at most, 15° C. at most, 17° C. at most, 20° C. at most, 22° C. at most, 25° C. at most, 27° C. at most, or 30° C. at most, or any value and range therebetween. Each possibility represents a separate embodiment of the invention.

In some embodiments, the temperature suitable for maintaining the distribution of each of the developmental stages of the predatory nematode as disclosed herein, such that the predatory activity towards a plant pathogenic nematode as disclosed herein is preserved, is 2-30° C., 3-28° C., 4-20° C., 5-18° C., 6-15° C., 1-7° C., 3-9° C., 5-29° C., 4-10° C., or 4-8° C. Each possibility represents a separate embodiment of the invention.

Agricultural carriers may be soil or a plant growth medium. Other agricultural carriers that may be used include water, fertilizers, plant-based oils, humectants, or combinations thereof Alternatively, the agricultural carrier may be a solid, such as diatomaceous earth, loam, silica, alginate, clay, bentonite, vermiculite, seed cases, other plant and animal products, or combinations, including granules, pellets, or suspensions. Mixtures of any of the aforementioned ingredients are also contemplated as carriers, such as but not limited to, pesta (flour and kaolin clay), agar or flour-based pellets in loam, sand, or clay.

In some embodiments, the acceptable carrier is an agriculturally suitable and/or environmentally acceptable carrier. Such carriers can be any material that an animal, a plant or the environment to be treated can tolerate. In some embodiments, “environmentally compatible carrier” or “ environmentally acceptable carrier” refers to any material, which can be added to the predatory nematode of the invention or a composition comprising same without causing or having an adverse effect on the environment, or any species or an organism other than the plant-parasitic nematode. Furthermore, the carrier must be such that the composition remains effective at controlling a plant-parasitic nematode (PPN).

### Method

According to some embodiments, there is provided a method for protecting a plant or a part thereof from a PPN, the method comprising treating the plant or a part thereof with an effective amount of the synthetic nematocidal composition of the invention.

As used herein, the terms “treating”, “applying” and “contacting” are interchangeable, and refer to the administration or supplementation of the herein disclosed synthetic nematocidal composition to any one of: a plant or a part thereof, a PPN, a growth medium comprising a plant, a growth medium comprising a PPN, or any combination thereof.

In some embodiments, the term “an effective amount”, as used herein, refers or comprises the number of nematodes provided/applied per plant, e.g., so as to protect the plant or a part thereof from a plant-parasitic nematode (PPN), as disclosed herein.

In some embodiments, an effective dose comprises at least 1,000 nematodes per plant, at least 2,500 nematodes per plant, at least 5,000 nematodes per plant, at least 7,500 nematodes per plant, at least 10,000 nematodes per plant, at least 20,000 nematodes per plant, at least 30,000 nematodes per plant, at least 40,000 nematodes per plant, at least 50,000 nematodes per plant, at least 70,000 nematodes per plant, at least 100,000 nematodes per plant, at least 200,000 nematodes per plant, at least 300,000 nematodes per plant, at least 400,000 nematodes per plant, or at least 500,000 nematodes per plant, or any value and range therebetween. Each possibility represents a separate embodiment of the invention.

In some embodiments, an effective dose comprises 1,000-100,000 nematodes per plant, 2,500-250,000 nematodes per plant, 5,000-400,000 nematodes per plant, 7,500-190,000 nematodes per plant, 10,000-100,000 nematodes per plant, 20,000-200,000 nematodes per plant, 30,000-275,000 nematodes per plant, 40,000-240,000 nematodes per plant, 50,000-200,000 nematodes per plant, 70,000-350,000 nematodes per plant, or 20,000-120,000 nematodes per plan. Each possibility represents a separate embodiment of the invention.

In some embodiments, treating comprises applying the synthetic nematocidal composition to a growth medium comprising the plant-parasitic nematode, the plant, or both.

In some embodiments, the applying or contacting is at a temperature ranging from 2-30° C., 13-28° C., 4-20° C., 15-25° C., 16-24° C., 10-17° C., 13-29° C., 5-19° C., or 14-20° C. Each possibility represents a separate embodiment of the invention.

In some embodiments, the applying or contacting is at a temperature of at least 2° C., at least 4° C., at least 6° C., at least 8° C., at least 10° C., at least 12° C., at least 15° C., at least 17° C., at least 20° C., at least 22° C., or at least 24° C. Each possibility represents a separate embodiment of the invention.

In some embodiments, applying is by irrigation or irrigating, drenching, dipping, soaking, injection, coating or spraying.

In some embodiments, applying is in an open field. In some embodiments, applying is in a greenhouse.

In some embodiments, treating comprises applying the synthetic nematocidal composition to the plant or a part thereof.

In some embodiments, protecting comprises ameliorating, preventing, or a combination thereof.

In some embodiments, treating is before the plant is planted.

In some embodiments, treating is at the day the plant is planted.

In some embodiments, treating is after the plant is planted.

In some embodiments, treating is before the plant is planted in a growth medium, and at the day the plant is planted in a growth medium.

In some embodiments, treating is before the plant is planted in a growth medium, and after the plant is planted in a growth medium.

In some embodiments, treating is at the day the plant is planted in a growth medium, and after the plant is planted in a growth medium.

In some embodiments, treating is before the plant is planted in a growth medium, at the day the plant is planted in a growth medium, and after the plant is planted in a growth medium.

In some embodiments, protecting comprises reducing the pathogenicity of the PPN. In some embodiments, reducing the pathogenicity of a PPN comprises predating of the PPN by the predatory nematode, reducing the survival of the PPN, or both.

In some embodiments, reducing the survival comprises directly or indirectly reducing the survival. In some embodiments, directly reducing the survival comprises killing or destroying the plant-parasitic nematode. In some embodiments, indirectly reducing the survival comprises not directly predating, killing or destroying the PPN but rather indirectly reduce their survival or viability, e.g., over competing for other resources, nutrients, niches, elements, or a combination thereof.

In some embodiments, reducing the pathogenicity of the PPN comprises: reducing the average number of eggs, cysts, J2, J3, adult male, adult female, or any combination thereof, of the PPN per weight of a part of the plant, reducing the root galling index of the root of the plant, reducing the penetration rate of the PPN to a part of the plant, reducing the number of the PPN penetrating a part of the plant, or any combination thereof.

In some embodiments, reducing is at least 5%, at least 15%, at least 25%, at least 35%, at least 50%, at least 75%, at least 85%, at least 90%, at least 95%, or 100% reduction, or any range or value therebetween. Each possibility represents a separate embodiment of the invention. In some embodiments, reducing is 5-10%, 7-15%, 15-25%, 20-35%, 30-50%, 45-75%, 60-85%, 70-90%, 80-95%, or 90-100% reduction. Each possibility represents a separate embodiment of the invention.

In some embodiments, a plant part comprises root, tuber, foliage, or any combination thereof.

In some embodiments, the plant comprises any plant that can be infected with a PPN. In some embodiments, the plant comprises any plant that can be attacked by a PPN. In some embodiments, the plant comprises any plant that attract a PPN. In some embodiments, the plant comprises an ornamental plant. In some embodiments, the plant comprises a fruit tree. In some embodiments, a plant comprises a citrus plant.

In some embodiments, the plant is a tomato. In some embodiments, the plant is a lettuce. In some embodiments, the plant is a cucumber. In some embodiments, the plant is an eggplant. In some embodiments, the plant is a tobacco plant. Examples of plants that can be affected by and attract nematodes include, but are not limited to corn, beans, soybeans, barley, hops, wheat, beats, eggplants, tomato, rice, tobacco, potato, onion, garlic, leek, carrot, pepper, cucumber, lettuce, apple, pineapple, grapevine, banana, citrus, avocado, mango, almond, peach, olive, turf, fern, Gladiolus, rose, carnation, ruscus, lily.

In some embodiments, the method further comprises treating the plant or a part thereof with an effective amount of a second nematocidal composition.

In some embodiments, the second nematocidal composition comprises the predatory nematode of the invention.

In some embodiments, the second nematocidal composition comprises primarily or predominantly adult predatory nematodes.

In some embodiments, predominantly comprises at least 50%, at least 60%, at least 70%, at least 80%, at least 90%, at least 95%, at least 97%, at least 99%, or 100% of the predatory nematodes in the second nematocidal composition, or any value and range therebetween. Each possibility represents a separate embodiment of the invention.

The terms “primarily” and predominantly” are used herein interchangeably.

In some embodiments, the second nematocidal composition consists essentially of the predatory nematode disclosed herein. In some embodiments, the second nematocidal composition consists essentially of adult predatory nematodes of the herein disclosed predatory nematode.

The terms “consists essentially of” or “consisting essentially of” denote that a given compound or substance, e.g., adult predatory nematode, constitutes the vast majority of the active ingredient's portion or fraction of the composition.

In some embodiments, the second nematocidal composition differs from the synthetic nematocidal composition of the invention in the distribution of the developmental stages of the predatory nematodes in the mixture.

In some embodiments, the second nematocidal composition comprises less dauers, less eggs, or both, of the predatory nematode compared to the synthetic nematocidal composition of the invention.

In some embodiments, the second nematocidal composition comprises more adults of the predatory nematode compared to the synthetic nematocidal composition of the invention.

In some embodiments, the distribution of dauers, eggs, or both, of the predatory nematode in the second nematocidal is lower or reduced compared to the distribution of dauers, eggs, or both, of the predatory nematode in the synthetic nematocidal composition of the invention.

In some embodiments, the distribution of adults of the predatory nematode in the second nematocidal is greater or increased compared to the distribution of adults of the predatory nematode in the synthetic nematocidal composition of the invention.

In some embodiments, lower or reduced is by at least 5%, at least 10%, at least 25%, at least 50%, at least 75%, or 100%, or any value and range therebetween. Each possibility represents a separate embodiment of the invention.

In some embodiments, lower or reduced is by 5-50%, 25-75%, or 10-100%. Each possibility represents a separate embodiment of the invention. Each possibility represents a separate embodiment of the invention.

In some embodiments, greater or increased is by at least 5%, at least 10%, at least 25%, at least 50%, at least 75%, at least 100%, at least 250%, at least 500%, at least 750%, or at least 1,000%, or any value and range therebetween. Each possibility represents a separate embodiment of the invention.

In some embodiments, greater or increased is by 5-50%, 25-75%, 10-100%, 50-350%, 100-400%, 150-550%, 450-785%, or 650-1,000%. Each possibility represents a separate embodiment of the invention.

In some embodiments, the second nematocidal composition is or represents an older or aged form of the synthetic nematocidal composition of the invention.

In some embodiments, older or aged is at least 3 days, at least 5 days older, at least 7 days older, at least 14, at least 30 days, at least 2 months older, compared to the synthetic nematocidal composition of the invention, or any value and range therebetween. Each possibility represents a separate embodiment of the invention.

For further clarification, the following is a non-limiting exemplary case, wherein a first potion or a first dose of the synthetic nematocidal composition is administered or applied at a given day, e.g., “day 0”. Thereafter, e.g., following at least 3 days, at least 5 days, at least 7, at least 10, and so forth, a second portion or a second dose is administered or applied, yet, the distribution of developmental stages of the predatory nematode has been modified as the different developmental stages further develop or progress along time, e.g., eggs hatch to juveniles, juvenile mature to adults, etc., thereby giving rise to a second nematocidal composition differing from the synthetic nematocidal composition by means of the distribution of developmental stages of the predatory nematode.

In some embodiments, the second nematocidal composition is an aged or older batch, portion, or dose, of the synthetic nematocidal composition.

In some embodiments, the second nematocidal composition is not derived from the synthetic nematocidal composition. In some embodiments, the second nematocidal composition does not originate from the synthetic nematocidal composition.

In some embodiments, treating is at least once, at least twice, at least thrice, at least four times, or at least five times 1 to 15 days, 1 to 10 days, 1 to 7 days, 1 to 5 days, 1 to 3 days, 2 to 10 days, 3 to 12 days, 4 to 10 days, 7 to 14 days, or 10 to 13 days, before the plant is planted in a growth medium, or any value and range therebetween. Each possibility represents a separate embodiment of the invention.

In some embodiments, treating is at least once, at least twice, at least thrice, at least four times, or at least five times 10 to 28 days, 12 to 21 days, 14 to 28 days, 12 to 28 days, 15 to 26 days, 16 to 25 days, 13 to 27 days, or 15 to 22 days, after the plant is planted in a growth medium.

In some embodiments, the PPN is an endo-parasite.

As used herein, the term “endo-parasite” refers to any parasitic organism that lives within a cell, a tissue, or an organ of a host.

In some embodiments, the PPN is an ecto-parasite.

As used herein, the term “ecto-parasite” refers to any parasitic organism that lives on an external surface of a host.

In some embodiments, the PPN is an ecto-endo-parasite.

In some embodiments, the PPN is capable of inducing a plant immune response in a plant infected by the PPN.

As used herein, the term “plant immune response” encompasses any response taking by a plant so as to protect itself from a parasite or pathogen, e.g., a nematode, and arthropod, or others.

In some embodiments, a plant immune response comprises gall formation.

As used herein, the term “nematode” refers to a roundworm belonging to the phylum Nematoda.

As used herein, the terms “plant-parasitic nematode” or PPN refer to a root-knot nematode. In some embodiments, a PPN belongs to the genus Meloidogyne. In some embodiments, a PPN belonging to the genus Meloidogyne is selected from: M. javanica, M. acronea, M. ardenensis Santos, M. arenaria, M. artielha, M. brevicauda, M. chitwoodi, M. coffeicola, M. exigua, M. frugha, M. gajuscus, M. hapla, M. incognita, M. enterolobii (i.e., mayaguensis), M. naasi, M. partityla, M. thamesi, and M. fallax.

In some embodiments, the PPN comprises M. incognita.

In some embodiments, the PPN comprises M. javanica.

In some embodiments, the PPN comprises a combination of M. incognita and M. javanica.

In some embodiments, the PPN belongs to the genus Pratylenchus. In some embodiments, the PPN is Pratylenchus capsici. In some embodiments, the method further comprises a step of treating the plant or a part thereof with a nematocidal agent or a nematode killing molecule.

In some embodiments, the nematode killing molecule is selected from: a polypeptide, a polynucleotide (such as an RNA polynucleotide), a chemical, or a small molecule. Nematode poisons are well known in the art and may be applied as part of the method of the invention to enhance the efficacy of the herein disclosed nematocidal composition in protecting a plant. Alternatively, as such poisons are often toxic to other organisms, including humans, the nematocidal composition of the invention is of extreme benefit as it functions without such additional toxins.

In some embodiments, a nematocidal agent or a nematode killing molecule is selected from: Nimitz, Viva, Bionem, or any combination thereof.

In some embodiments, a nematocidal agent comprises any nematocidal agent known in the art, as long as it does not kill or affects the predatory nematode of the invention.

In some embodiments, the nematocidal agent is inert to the predatory nematode of the invention.

In some embodiments, there is provided a method for preventing or treating a plant afflicted with a nematode-induced damage or disease, comprising contacting the plant with an effective amount of the nematocidal composition of the invention.

As used herein, the term “ameliorating” encompasses alleviation of at least one symptom thereof, a reduction in the severity thereof, or inhibition of the progression thereof. Treatment need not mean that the disease, or damage is totally cured. To be an effective treatment, a useful composition herein needs only to reduce the severity of a disease, or damage, reduce the severity of symptoms associated therewith, or provide improvement to a plant's wellbeing. In some embodiments, treating a nematode-induced damage comprises predating a plant-parasitic nematode, thereby reducing the pathogenicity of the plant-parasitic nematode to the plant.

As used herein, the term “prevention” encompasses the delay, prevention, suppression, or inhibition of the onset of a disease, or damage. As used in accordance with the presently described subject matter, the term “prevention” relates to a process of prophylaxis in which a plant or a part thereof is grown in growth media that is exposed to the presently described composition prior to the induction or onset of the disease/damage. The term “suppression” is used to describe a condition wherein the disease/damage has already begun but obvious symptoms of the condition have yet to be realized. In either case, the term prophylaxis can be applied to encompass both prevention and suppression. In some embodiments, preventing nematode-induced damage comprises predating a plant-parasitic nematode in the growth media before, at, or after the planting of the plant.

As used herein, the term “growth medium” refers to any solid, liquid or semi-solid designed to support the growth of a plant. In some embodiments, growth medium is soil or dirt. In some embodiments, the growth medium comprises a plant-pathogenic nematode. In some embodiments, the growth media is infested with a plant-pathogenic nematode. In some embodiments, the growth medium is suitable to support a plant-pathogenic nematode.

### General

In the discussion unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a”, “an” and “at least one” are used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

In the description and claims of the present application, each of the verbs, “comprise”, “include” and “have” and conjugates thereof, are used to indicate that the object or objects of the verb are not necessarily a complete listing of components, elements or parts of the subject or subjects of the verb.

Other terms as used herein are meant to be defined by their well-known meanings in the art.

Unless specifically stated or obvious from context, as used herein, the term “or” is understood to be inclusive.

Throughout this specification and claims, the word “comprise” or variations such as “comprises” or “comprising,” indicate the inclusion of any recited integer or group of integers but not the exclusion of any other integer or group of integers.

As used herein, the term “consists essentially of”, or variations such as “consist essentially of” or “consisting essentially of” as used throughout the specification and claims, indicate the inclusion of any recited integer or group of integers, and the optional inclusion of any recited integer or group of integers that do not materially change the basic or novel properties of the specified method, structure or composition.

As used herein, the terms “comprises”, “comprising”, “containing”, “having” and the like can mean “includes”, “including”, and the like; “consisting essentially of” or “consists essentially” likewise has the meaning ascribed in U.S. patent law and the term is open-ended, allowing for the presence of more than that which is recited so long as basic or novel characteristics of that which is recited is not changed by the presence of more than that which is recited, but excludes prior art embodiments. In one embodiment, the terms “comprises”, “comprising”, “having” are/is interchangeable with “consisting”.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Generally, the nomenclature used herein, and the laboratory procedures utilized in the present invention include molecular, biochemical, microbiological, and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Maryland (1989); Perbal, “A Practical Guide to Molecular Cloning”, John Wiley & Sons, New York (1988); Watson et al., “Recombinant DNA”, Scientific American Books, New York; Birren et al. (eds.) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells—A Manual of Basic Technique” by Freshney, Wiley-Liss, N. Y. (1994), Third Edition; “Current Protocols in Immunology” Volumes I-III Coligan J. E., ed. (1994); Stites et al. (eds), “Basic and Clinical Immunology” (8^{th} Edition), Appleton & Lange, Norwalk, CT (1994); Mishell and Shiigi (eds), “Strategies for Protein Purification and Characterization-A Laboratory Course Manual” CSHL Press (1996); all of which are incorporated by reference. Other general references are provided throughout this document.

### Materials and Methods

### General Protocol for Pot Experiments

One (1) liter or 4 L pots were filled with sandy soil and infested with ca. 2,000 or ca. 4,000, respectively, of second-stage juveniles (J2) of the root-knot nematode, Meloidigyne javanica (M.j.). Ten (10) days before planting, 5 days before planting, and/or at the day of planting, 4,000 or 8,000 of Allodiplogaster (=Koerneria)sudhausi (A.s.=K.s.) were added to the M.j.-infested soil.

A host plant, e.g., tomato, cucumber, or lettuce, was then planted and the experiments were performed in a temperature-controlled (27±2° C.) growth chamber, with eight replicates for each treatment. Forty-five (45) days after planting, plants were harvested, roots were washed carefully and weighted, and the nematocidal activity of Allodiplogaster (=Koerneria) sudhausi (A.s.=K.s.). was assessed by evaluation of the galling index (on a scale between 0-5) of each root, by counting the total number of eggs of M.j. per each root, and calculating the number of eggs of M.j. per gr root.

### EXAMPLE 1

### Predation of the Plant-Parasitic Nematode Meloidogyne Javanica

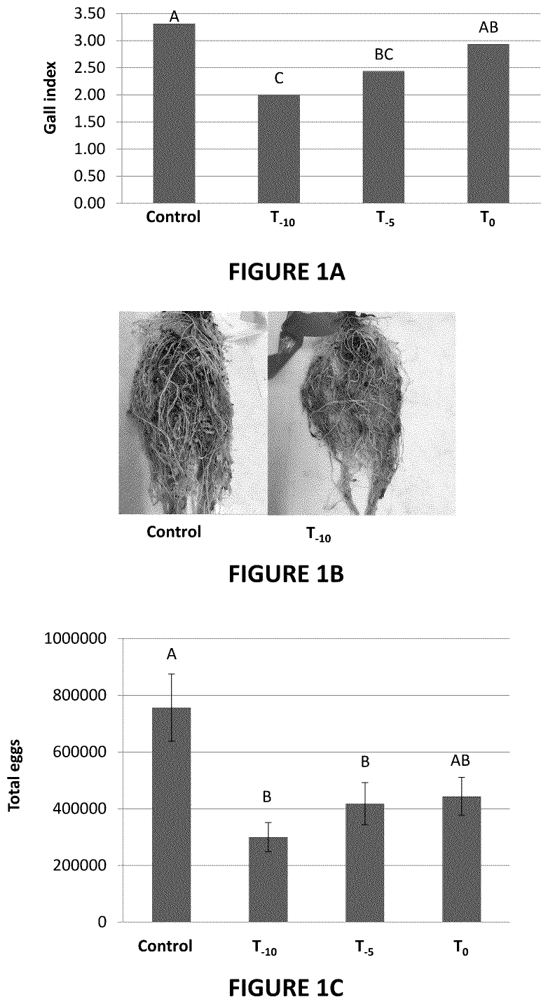

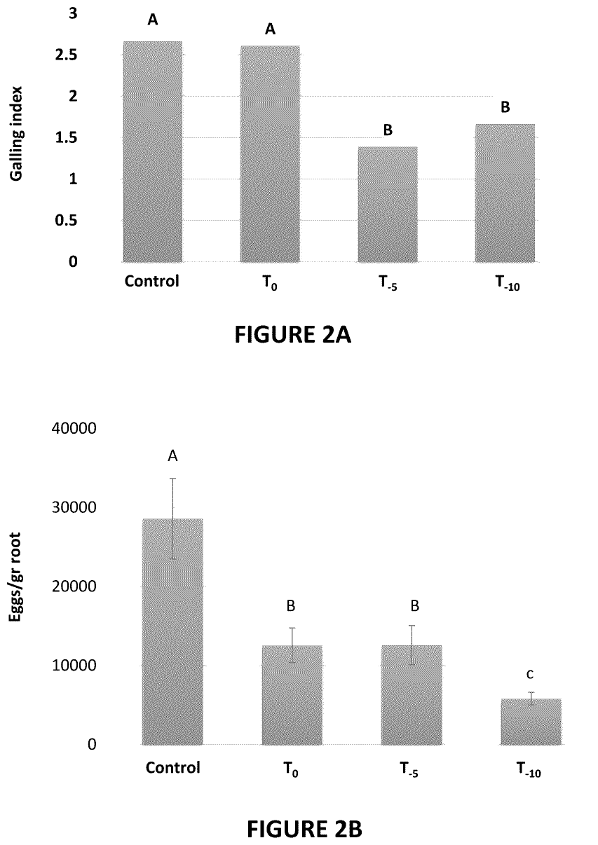

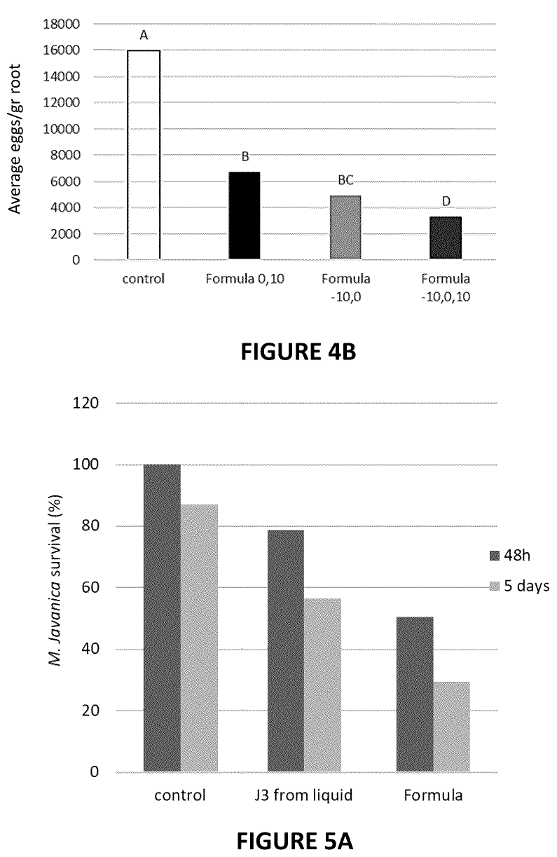

The inventors showed that pre planting application of predatory nematodes, reduces infection of M.j (FIGS. 1, 2, and 4) in tomato plants. Specifically, treatment with predatory nematodes 10 days before planting (T₋₁₀) reduced galling index (FIGS. 1A,2A, and 4A), the total number of M.j. eggs collected from the nematode-infected roots of tomato (FIG. 1C), and M.j. eggs per gr roots (FIGS. 2B, and 4B).

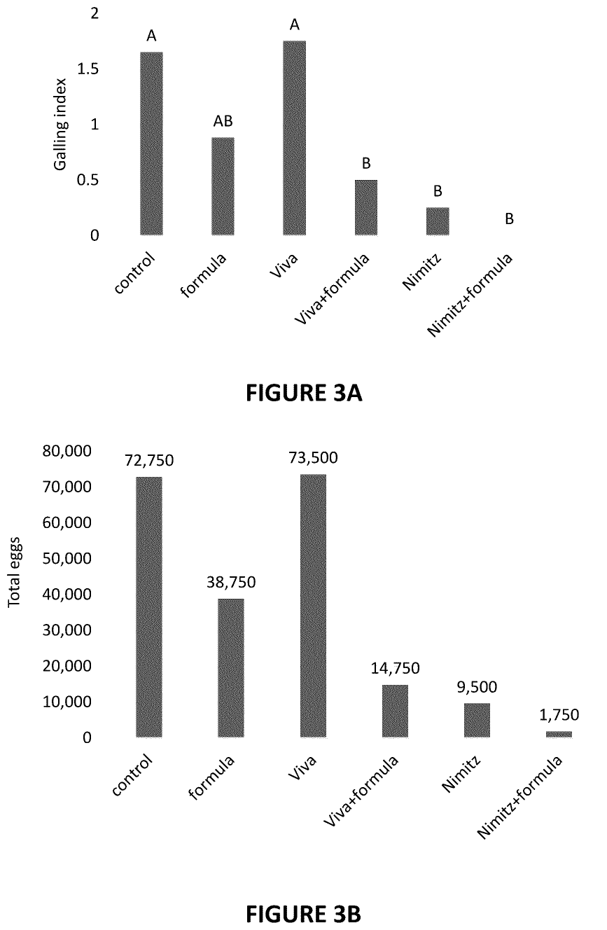

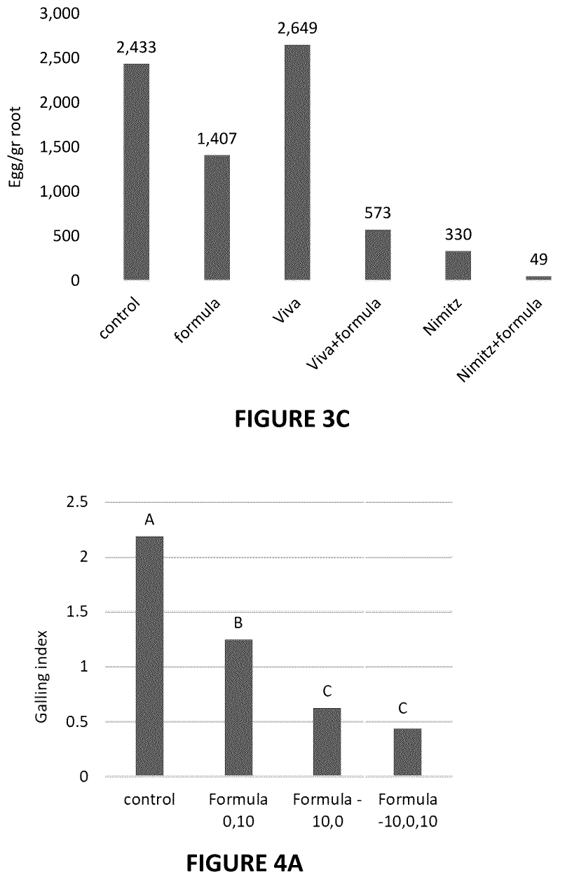

The inventors further showed the enhanced nematocidal effect on M.j.-infected plants of the formulated-predatory nematodes of the invention when applied concomitantly with a chemical nematocidal agent. The combination of the predatory nematodes of the invention and the nematocidal agent Nimitz was found to be very effective as reflected by the reduced: galling index (FIG. 3A), the total number of M.j eggs per root (FIG. 3B) and M.j. eggs per gr roots (FIG. 3C).

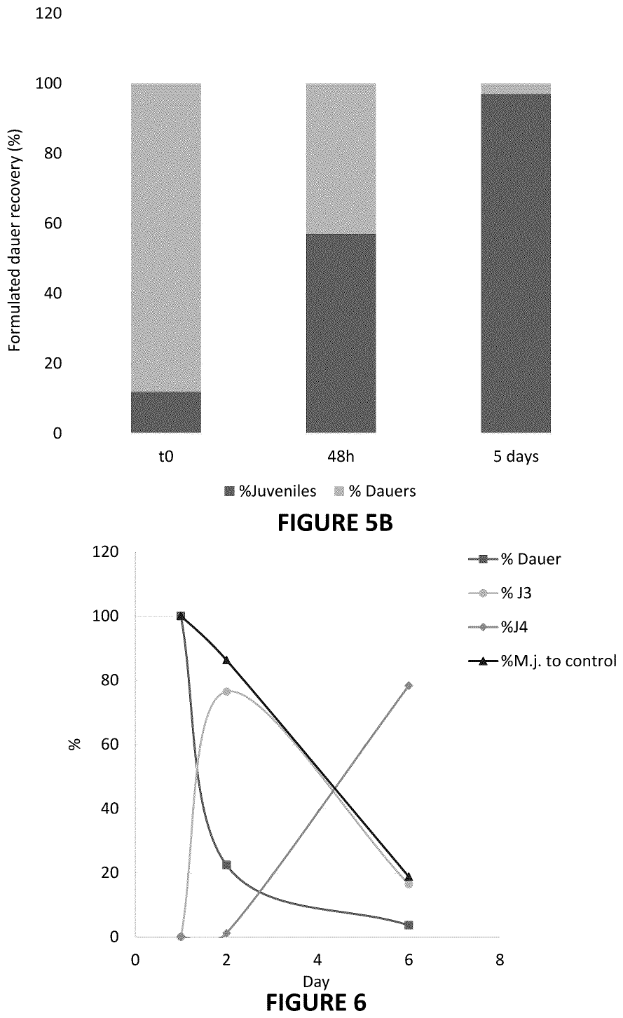

The inventors showed that predation of M.j. by A. sudhausi increased over time, as reflected by the reduced survival of M.j. after 48 hours compared to control, and even more so after 5 days (FIG. 5A). The inventors further showed the dynamics of the predatory developmental stages in the formula at the same time points as in FIG. 5A, showing increase in juvenile predatory nematodes abundance and decrease of predatory nematode dauers (FIGS. 5B and 6), and simultaneously the reduction of M.j. survival over time (FIG. 6).

Further, the inventors examined the effect of the synthetic composition of the invention to treat cucumber plants, wherein the composition was applied either by drenching (hand application) or by irrigation (drip irrigation).

The experiment included cucumber plant, and the plant parasitic/pathogenic nematode M. javanica. Each plant of the treatment group was applied with approximately 30,000 predatory nematodes as disclosed herein (A. sudhausi).

Control, 180 plants; Drench, 120 plants; and Drip irrigation, 180 plants.

The experiment included a first, pre-plant treatment before planting, and 3 subsequent treatment after planting. For analysis, 30 plants were harvested from the control and drip irrigation, and 20 plants from the drenching group. The results show that both treatment groups reduced the galling index (FIG. 8). The reduction of gall index in the drip irrigation group was found to statistically significant compared to the control.

Further, the inventors examined the survival of the predatory nematode after the production as a dependency of temperature.

The inventors found that preservation at a temperature ranging from 2° C. to 10° C., e.g., 4-8° C. is suitable.

Further, the inventors found that more than 50% survival is achieved when predatory nematodes are applied to a target soil at a temperature ranging from 15° C. to 25° C.

### EXAMPLE 2

### Predation of the Plant-Parasitic Nematode Pratylenchus Capsici

To examine the predation capabilities of A.s. across species, the inventors have used Pratylenchus capsica as a target.

The experiment was performed in Petri plates (50 mm) supplemented with agar. The number of Pratylenchus per plate was ca. 65. The number of A.s. per plate was: (i) ca. 500; or (ii) ca. 1,000.

Plates: Control (P. capsici only)—n=6; Predation tests: (i) 500 A.s.—n=8, and (ii) 1,000 A.s.—n=8.

P. capsici were placed on the plate, and 24 h later, 500 and 1000 A.s. were added to the treated-plates. The number of living P. capsici remained on plates was counted after 24 and 48 hours.

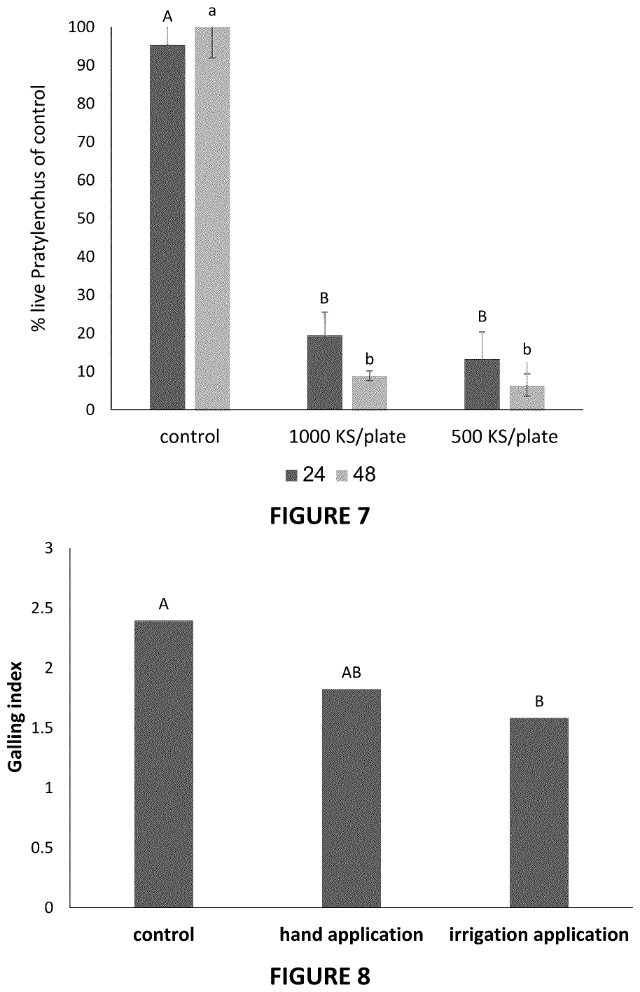

The results show that the A.s. successfully and efficiently fed on P. capsici. Specifically, P. capsici survival rates were 20% or less after either 24 hours or 48 hours, regardless if incubated with 500 or 1,000 A.s (FIG. 7).

### EXAMPLE 3

### The Effect of Different Carriers on the Shelf Life of Predatory Nematodes

At the end of the mass production process in liquid media, in orbital shakers or bio fermenters, the predatory nematodes were harvested by sieving and separated from the media by centrifugation. A yellow paste comprising a very high density of nematodes was obtained. According to this procedure, the obtained nematodes' shelf life was relatively short.

Therefore, the inventors sought to improve this marketing drawback, such as by the implementation of new storage methods.

The inventors have examined the packing and storage capabilities of different carriers, as described hereinbelow.

The carriers that were tested were: sponge, gauze pads, non-woven fabrics in different densities, and wipes. In addition, different gels, such as: Carrageenan gels, and alginate beads, liquid and semi-solid media, clay in different humidity levels, polycarbonate, silica and the afore-mentioned nematode paste per se, were tested.

Carriers were examined in different vessels, including: Ziploc bags, plastic tubes, and shaker flasks, as well as in different temperatures: 4° C., 10° C., 15° C., and 25° C.

Best results were recorded for nematodes kept at 4° C., in high humidity, as a paste or as a mixture of the paste with clay or agar.

The highest percentage of nematode survival achieved was 50% with the Carrageenan gels after two weeks at 4° C. Adding bacteria (E. coli OP50) to the NGM agar media improved conservation by approximately 10%, as compared to the Carrageenan gels alone.

A particularly satisfying formulation the inventors used comprised a mixture of the nematodes' paste that was obtained after sieving the liquid culture, formulated with clay, so as to provide a moist powder stored, and stored at 4° C. In this formulation, the nematodes' survival rate was up to 50%. After 2-3 weeks storage commenced, the survival rate was up to 80%.

In most of the above-mentioned experimental groups (as also present in the table hereinbelow), the resulting nematode population comprised a mixture of different life-stages, primarily, juveniles, adults, and a small percentage of dauers.

| | | | With this respect, the clay- |
|---|---|---|---|
| | | | based formulations, |
| | | | comprised higher percentage |
| | | | of eggs and dauers, which are |
| | | | considered to be more |
| Storage | | | resistant to environmental and |
| temp | Formula/ | | storage conditions. % survival |
| (° C.) | carrier | Vessel | (after 10-14 days) |
| 4 | Gauze pad | Petri plate | 28 |
| 4 | Felt | Petri plate | |
| 4 | Paste only | Petri plate | 48 |
| 25 | Gauze pad | Petri plate | 2.6 |
| 25 | Felt | Petri plate | 5.6 |
| 25 | Paste only | Petri plate | 14 |
| 4 | Gauze pad | 50 ml tube | Less than 10% |
| 4 | Felt | 50 ml tube | Less than 10% |
| 4 | Paste only | 50 ml tube | Less than 10% |
| 4 | Wipes | 50 ml tube | Less than 10% |
| 4 | Water | 50 ml tube | Less than 10% |
| 4 | Paste on felt | Ziploc bag | 30 |
| 4 | Paste on felt | Petri plate | 25 |
| 4 | Paste on felt | 50 ml tube | 5 |
| 4 | Carrageenan gel | Petri plate/ | 50 |
| | | Ziploc bag | |
| 4 | NGM agar + | | 60 |
| | E. coli OP50 | | |
| 4 | Clay low moist | | 40 |
| 4 | Clay high moist | | 70 |

While the present invention has been particularly described, persons skilled in the art will appreciate that many variations and modifications can be made. Therefore, the invention is not to be construed as restricted to the particularly described embodiments, and the scope and concept of the invention will be more readily understood by reference to the claims, which follow.

1. A synthetic nematocidal composition comprising a mixture of developmental stages of a predatory nematode belonging to the genus Allodiplogaster comprising eggs, juveniles, dauers, and adults, and an acceptable carrier.

2. The synthetic nematocidal composition of claim 1, wherein at least 2% of said predatory nematodes in said mixture are dauers, optionally wherein any one of: (i) at least 10% of said predatory nematodes in said mixture are dauers; (ii) at least 10% of said predatory nematodes in said mixture are eggs; (iii) said predatory nematode is Allodiplogaster sudhausi; and (iv) any combination of (i) to (iii).

3.-5. (canceled)

6. The synthetic nematocidal composition of claim 1, wherein said acceptable carrier is selected from the group consisting of: a liquid carrier, a gel carrier, a mineral carrier, a solid carrier, and any combination thereof, and optionally wherein: (i) said liquid carrier is further encapsulated in a suitable compound; (ii) said mineral carrier comprises silicium dioxide, vermiculite, diatomaceous earth, or a combination thereof, or both.

7.-8. (canceled)

9. The synthetic nematocidal composition of claim 1, wherein said carrier is further formulated with water, so as to provide moist environment, aerated environment, or both, to said mixture of developmental stages of said predatory nematode.

10. The synthetic nematocidal composition of claim 1, wherein said mixture of predatory nematode and said carrier are present in said synthetic nematocidal composition in a weight per weight (w/w) ratio ranging from 1:40 to 1:100.

11. A method for protecting a plant or a part thereof from a plant-parasitic nematode, the method comprising treating said plant or a part thereof with an effective amount of the synthetic nematocidal composition of claim 1, and optionally wherein said treating comprises applying said synthetic nematocidal composition to a growth medium comprising said plant-parasitic nematode, said plant, or both.

12. (canceled)

13. The method of claim 11, wherein said treating comprises applying said synthetic nematocidal composition to said plant or a part thereof.

14. The method of claim 11, wherein said treating is before said plant is planted, at the day said plant is planted, after said plant is planted, or any combination thereof.

15. The method of claim 11, wherein said protecting comprises reducing the pathogenicity of said plant-parasitic nematode, and optionally wherein said reducing the pathogenicity of said plant-parasitic nematode comprises predating of said plant-parasitic nematode by said predatory nematode, reducing the survival of said plant-parasitic nematode, or both.

16. (canceled)

17. The method of claim 15, wherein said reducing the pathogenicity of said plant-parasitic nematode comprises: reducing the average number of eggs, cysts, J2, J3, J4, adult male, adult female, or any combination thereof, of said plant-parasitic nematode per weight of a part of said plant, reducing the root galling index of the root of said plant, reducing the penetration rate of said plant-parasitic nematode to a part of said plant, reducing the number of said plant-parasitic nematode penetrating a part of said plant, or any combination thereof.

18. The method of claim 11, wherein said part of a plant comprises root, tuber, foliage, or any combination thereof.

19. The method of claim 11, wherein said treating is at least once 1 to 15 days before said plant is planted.

20. The method of claim 11, wherein said treating is at the day said plant is planted.

21. The method of claim 11, wherein said treating is at least once 5 to 28 days after said plant is planted.

22. The method of claim 11, wherein said plant-parasitic nematode is an endo-parasite, an ecto-parasite, or an ecto-endo parasites.

23. The method of claim 11, wherein said plant-parasitic nematode is capable of inducing a plant immune response in a plant infected by said plant-parasitic nematode.

24. The method of claim 23, wherein said plant immune response comprises gall formation.

25. The method of claim 11, wherein said plant-parasitic nematode belongs to the genus Meloidogyne or Pratylenchus.

26. The method of claim 11, wherein said plant-parasitic nematode comprises M. incognita, M. javanica, P. capsici, or any combination thereof.

27. The method of claim 11, further comprising a step of treating said plant or a part thereof with a nematocidal agent.
